(19) United States
(12) Patent Application Publication
(10) Pub. No.: US 2010/0063310 A1
(43) Pub. Date: Mar. 11, 2010

(54) Functionalized silicon compounds

(76) Inventors: Jeffrey A. Knepper, Branchburg, NJ (US); Jacques Geenen, Madison, NJ (US); Edward Asirvatham, Chatham, NJ (US); Suzanne Wassman-Wilken, Hannover (DE)

Correspondence Address: HONEYWELL INTERNATIONAL INC.;PATENT SERVICES, 101 COLUMBIA ROAD, P O BOX 2245, MORRISTOWN, NJ, 07962-2245, US

(21) Appl. No.: 11/630,357

(22) PCT Filed: Jul. 1, 2005
(86) PCT No.: PCT/US05/23597

§ 371 Date: Feb. 17, 2009

Related U.S. Application Data
(60) Provisional application No. 60/585,416, filed on Jul. 2, 2004.
(60) Provisional application No. 60/645,429, filed on Jan. 20, 2005.

(51) Int. Cl. C07F 7/18

(52) U.S. Cl. 556/438

(57) ABSTRACT

A process for preparing a functionalized carbo-silicon compound comprising contacting, in the presence of a hydrosilation catalyst and under hydrosilation promoting conditions: a hydrolyzable silicon reactant having at least one Si—H functional group, and a functionalized olefin reactant containing at least one terminal olefin functional group and a tertiary carbon atom to which is bonded a second functional methyl group or functional carbon group characterized by having substantial potential to impede a hydrosilation reaction when otherwise not attached to the tertiary carbon atom.

### BACKGROUND OF THE INVENTION

1. Field of Invention

The present invention relates to a process for hydrosilation of unsaturated hydrocarbons in the synthesis of carbo-silanes and carbo-siloxanes and the carbo-silanes and carbo-siloxanes prepared thereby.

2. Description of Related Art

Carbo-silane and carbo-siloxane compounds have useful surface-active properties and find wide utility as surfactants in various hydrophilic and lipophilic solvent systems. In addition, carbo-silane and carbo-siloxane compounds, particularly those with reactive functional groups, find wide use as intermediates in the production of dimer, oligomer, and polymer compounds having various regions which will interact with a wide variety of hydrophilic and lipophilic materials. The preparation of carbo-silanes and carbo-siloxanes utilizing a hydrosilation reaction, that is, a reaction comprising the addition of an Si—H (silane) functional group contained in a silicon reactant across an unsaturated functional group in a olefin reactant is generally known, see for example, A. J. Chalk and J. F. Harrod, Journal of the American Chemical Society (1965) 87(1) pp 16-21. An example of such a hydrosilation reaction is the addition of trimethylsilane (H—Si(CH₃)₃), to an olefin, for example 1-butene, to form trimethylsilyl butane [(CH₃)₃Si(CH₂)₃—CH₃)]. This type of reaction is considered fundamental to the provision of carbo-silane and carbo-siloxane compounds.

In general, hydrosilation reactions are carried out by heating a reaction mixture comprising a stoichiometric excess of the olefin reactant and a hydrosilation catalyst, for example, chloroplatinic acid, and adding the silicon reactant to the mixture in small aliquots. The expected course of a hydrosilation reaction when the olefin reactant contains a terminal olefin is that the silicon atom of the silane functional group in the silicon reactant loses a hydrogen atom and is bonded to the terminal carbon of the olefin functional group of the olefin reactant and a hydrogen atom is concomitantly bonded to the beta-carbon of the terminal olefin functional group. This result is sometimes termed herein for convenience as a typical hydrosilation reaction.

However, when the olefin reactant contains certain functional groups, the hydrosilation reaction either does not proceed or does not provide the above-described expected addition product. That is, certain hydrosilation reactions fail because the expected hydrosilation of the unsaturated carbon functional group is not achieved and certain other hydrosilation reactions fail because an undesirable amount of the olefin reactant is consumed in by-product reactions. Examples of functional groups that have the potential of substantially impeding a hydrosilation reaction include, but are not limited to, groups which are reducent under hydrosilation conditions, for example, an aldehyde. This is particularly true when such functional groups are appended to a carbon wherein conjugation with the olefin functional group undergoing hydrosilation is possible. Non-limiting examples of this latter bonding pattern is seen in, for example, acrolein (H₂C═CH—CHO). In olefin reactants, other functionality and bonding arrangements which yield this result when a typical hydrosilation reaction is attempted are also known.

Heretofore, this problem has been addressed for some olefin reactants by derivatizing one or more functional groups of the olefin reactant with a “protecting group” which mitigates the potential of the functional group(s) to impede the hydrosilation reaction. An example of hydrosilation reaction scheme utilizing a derivatized olefin reactant is reported by Dennis et al. in the Journal of Organic Chemistry, 35(12) pp 4180 to 4183 (the Dennis publication). The Dennis publication describes preparation of acrolein dimethyl acetal (an acetal derivative prepared from the aldehyde functional group of acrolein) as an olefin reactant, and utilizes it in a hydrosilation reaction with 1,1,2,2,2-pentamethyldisiloxane (a silicon reactant, (CH₃)₃SiO(CH₃)₂Si—H). This hydrosilation reaction described in the Dennis publication yields substantial conversion (about 65 mole %) of the derivatized olefin reactant (acrolein dimethylacetal) to the expected hydrosilation product, that is, addition of the silane functional group of the silicon reactant across the olefin functional group of the olefin reactant. The Dennis publication describes also hydrolysis of the acetal functional group of the product carbo-silane thus providing a carbo-silane product which contains an aldehyde functional group. The Dennis publication notes, however, that this reaction does not yield the expected hydrosilation addition reaction when carried out utilizing trichlorosilane (H—SiCl₃) as the silicon reactant. It will be appreciated that trichlorosilane is a silicon reactant which has a hydrolyzable substituent (Cl) bonded to the silicon atom of a silane functional group.

It will be appreciated from the forgoing that had Dennis et al. identified a hydrocarbon reagent which would provide the expected hydrosilation product, that is, a carbo-silane containing a hydrolyzable functional group on silicon, the acetyl “protecting” group could not be hydrolyzed to reform the aldehyde since that would hydrolyze also the functional groups on silicon. Accordingly, the synthetic scheme described by Dennis is unsuited to preparing carbo-silanes and -siloxanes which contain functionality having a substantial potential to impede a hydrosilation reaction and contain also hydrolyzable substituents on a silicon atom therein.

In addition it will be appreciated that the synthetic scheme described in the Dennis publication introduces additional steps into the process for preparing carbo-silanes and carbo-siloxanes containing a functional group which substantially impedes a hydrosilation reaction by including a step which forms a derivative of the desired functional group before the hydrosilation reaction and a step converting the derivative back to the desired functional group after the hydrosilation reaction. These additional steps negatively affect the efficiency and cost of the preparative process.

Applicants have thus come to appreciate that there is a need for a method which provides for the direct preparation of functionalized carbo-silanes, -siloxanes and oligomers, polymers, and copolymers thereof, which are characterized in that the silane and siloxane compounds contain functionality having a substantial potential to impede a typical hydrosilation reaction. Applicants have also come to appreciate that there is a need for a method which provides for the direct preparation of carbo-silanes and carbo-siloxanes having a silicon-containing portion which has one or more hydrolyzable functional groups bonded to a silicon atom thereof and which has a hydrocarbon portion containing functionality having a substantial potential to impede a hydrosilation reaction. Needed also are carbo-silanes and carbo-siloxanes containing functionality having a substantial potential to impede a hydrosilation reaction and which contain also functional groups bonded to a silicon atom therein which are hydrolyzable.

These needs, among others, are met by the present invention, and other advantages and embodiments of the present invention will become apparent from the following description.

### SUMMARY OF THE INVENTION

Applicants have discovered a process for synthesizing functionalized carbo-silanes and carbo-siloxanes which were heretofore difficult, if not impossible, to produce. As used herein, the terms “functionalized carbo-silane” and “functionalized carbo-siloxane,” refer to a silane and siloxane, respectively, having a reactive functional group, such as, for example, an aldehyde or nitrile group.

In general, it is desirable to synthesize functionalized carbo-silanes and carbo-siloxanes by reacting a silane or siloxane with a reactant comprising a desired functional group at one end, and an olefin group at the other end. Under certain conditions, a hydrosilation reaction occurs between the carbon-carbon double bond of the reactant and an Si—H portion of the silane or siloxane to produce carbo-silane or carbo-siloxane having the desired [symbol] Silane/Siloxane al, this cc Reactant :an be represented as:

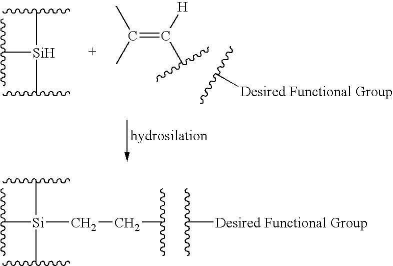

The applicants have discovered, however, that this method is not effective at synthesizing functionalized carbo-silanes and carbo-siloxanes in which the functional group is similar to or greater than the vinyl group in reactivity during hydrosilation. In such instances, the functional group may tend to bond directly to the silane or siloxane or may undergo some other undesirable reaction. To overcome this problem, the applicants have discovered that a tertiary carbon may be positioned between the reactive functional group and the rest of the reactant so as to hinder or impede the reactivity of the reactive functional group. As the term is used herein, a “tertiary carbon moiety” is a carbon which has no protons directly bonded to it, but rather is bonded to three alkylene substituents in addition to the aforementioned functional group.

Without being bound to any particular theory, applicants suspect that the tertiary carbon atom reduces the reactivity of the functional group during hydrosilation in at least one or two ways. First, given the position of the tertiary carbon between the functional group and the olefin group, it eliminates the functional group's ability to conjugate with the terminal olefin group. Second, applicants suspect that two of the alkylene substituents may act as protecting groups on the tertiary carbon to crowd the functional group, thereby stearicly hindering reactions with the functional group during hydrosilation. In this regard, increasing the size of the R² and R³ (e.g. phenyl vs. methyl) substituents tends to further reduce the reactivity of the functional group during hydrosilation.

This process can generally be represented as:

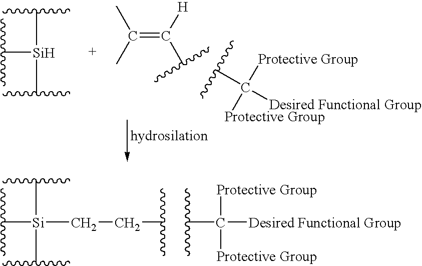

One aspect of the invention is a process for preparing functionalized carbo-silanes or carbo-siloxanes by reacting a silicon containing reactant with a functionalized olefin in which the reactive functionality is separated from the unsaturated bonds by a tertiary carbon having protecting groups to impede the reactivity of the functional group during hydrosilation.

In a preferred embodiment, the process for preparing a functionalized carbo-silane or carbo-siloxane compounds comprises contacting, in the presence of a hydrosilation catalyst and under hydrosilation promoting conditions, a silicon reactant containing at least one Si—H functional group and a functionalized olefin reactant which contains:
i. at least one terminal olefin functional group;
ii. an alkylene segment bonded to at one end to said terminal olefin functional group; and
iii. a tertiary carbon moiety bonded to the other end of the alkylene segment and comprising a reactive functional group along with two protective groups to impede the reactivity of the functional group during hydrosilation.
   But for the protective groups, the character and bonding position of the reactive functional group is such that it would have a substantial potential to impede a typical hydrosilation reaction.

In certain preferred embodiments of this aspect of the invention, a process is provided for preparing a functionalized carbo-silane or carbo-siloxane compound comprising contacting, in the presence of a chloroplatinic acid hydrosilation catalyst and under hydrosilation promoting conditions, a silicon reactant having the general formula:

Si(Z)_{b}(H)ₐ(R¹)_{4-b-a}
wherein “Z” is a hydrolyzable substituent including, for example, alkoxy, halogen, ketoximino, dialkylamino, acetamide, alkylthio, N,N-dialkylaminoxy, benzamide, acyloxy, and enoxy;
   “R¹” is a substituent including, for example, moieties independently selected from the group consisting of: (i) silicon-based moieties selected from the group consisting of silanes, carbosilanes, linear, branched, and cyclic siloxanes,carbosiloxanes, and oligomers, polymers, and copolymers of two or more thereof, which are optionally substituted with one or more hydrolyzable functional groups on one or more silicon atoms thereof; and (ii) saturated or unsaturated, linear, branched, or cyclic, aliphatic or aromatic, hydrocarbon moieties which are optionally substituted on any carbon thereof with an alkyl, aryl, hydroxyl, alkoxy, or halogen moieties.
   “a” is an integer equal to 1, 2, or 3; and
   “b” is an integer equal to 0, 1, 2, or 3;
   provided that a+b≦4;
      and a functionalized olefin reactant having the general formula:

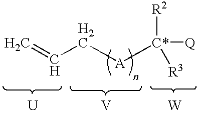

wherein section “U” designates an unsaturated hydrocarbon functional group;
   section “V” designates an alkylene moiety;
   section “W” designates the tertiary carbon moiety having a second functional group and two blocking groups;
   “A” is alkylene moiety including, for example, —[CH₂]_{c}—S—[CH₂]_{d}, —[CH₂]_{c}—O—[CH₂]_{d}, and —[CH₂]_{c}—N(R⁴)[CH₂]_{d}—, wherein “c” is an integer including 0, “d” is at least one, and R⁴ is an alkyl moiety having less than about three carbon atoms;
   “R²” is selected from the group consisting of saturated or unsaturated, linear, branched, or cyclic, aliphatic, aromatic, and substituted aromatic hydrocarbon moieties, including, for example, methyl, ethyl, and phenyl;
   “R³” is selected from the group consisting of saturated or unsaturated, linear, branched, or cyclic, aliphatic, aromatic, and substituted aromatic hydrocarbon moieties, including, for example, methyl, and phenyl
   “Q” is a second functional group having, in the absence of the tertiary carbon moiety in section W, a substantial potential to impede a hydrosilation reaction; and
   “n” is an integer equal to 0 or 1.

Another aspect of the invention are the functionalized carbo-silanes and carbo-siloxanes compounds made from this process. Optionally, a hydrolyzable functional group is attached to one or more silicon atom in the carbo-silane or carbo-siloxane. In certain preferred embodiments, provided are novel compounds having the formula:

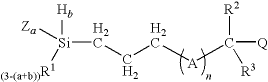

wherein
“a” and “b” are integers, including zero, selected independently such that a+b is equal to or less than 3, and
“Z”, “Q”, “A”, “n”, “R¹”, “R²”, and “R³” are as defined above.

### DETAILED DESCRIPTION OF THE INVENTION

The inventors have surprisingly found that reactants having a terminal unsaturated functional group and a second terminal function group, the combination of which is conventionally thought to impede a hydrosilation reaction, can be successfully employed in a hydrosilation reaction by placing a tertiary carbon moiety between the unsaturated functional group and the second functional group. Accordingly, the process of the present invention comprises a hydrosilation reaction between a silane functional group of a silicon reactant and a terminal olefin group of a functionalized olefin reactant. This discovery is in contrast to the conventional belief that olefin reactants having a terminal olefin group and certain functional groups, such as those that are reducent under hydrosilation conditions, will impede a typical hydrosilation reaction due to the presence of competing reactions, the production of unwanted by-products, and/or deactivate the desired hydrosilation reaction site.

Although the process and compounds of the present invention are described and exemplified below using simple silanes and siloxanes as the silicon reactant and several low molecular weight olefins functionalized with aldehyde and nitrile functional groups as the functionalized olefin reactant, it will be appreciated that the present invention has wider applicability with regard to the structure of the silicon and functionalized olefin reactants and the functional groups contained in each.

As the term is used herein, and without reference to any particular mechanism by which the reaction occurs, a hydrosilation reaction is generally characterized by a reaction at the silicon-hydrogen bond of a silane or siloxane silicon reactant that involves the addition of the silane or siloxane across the terminal carbon-carbon double bond of the olefin reactant.

As it is used herein, the term “silane” refers to an Si—H functional group or a compound containing an Si—H functional group. As it is used herein, the term “siloxane” refers to a compound comprising at least one Si—O—Si moiety, which may additionally contain one or more Si—H functional groups. As it is used herein, the term “carbo-silane” refers to a compound which contains at least one carbon moiety bonded to a silicon atom therein (Si—C), and may contain in addition one or more Si—H functional groups. As it is used herein, the term “carbo-siloxane” refers to a compound which contains at least one Si—O—Si moiety, and which has bonded to at least one silicon atom thereof at least one hydrocarbon moiety. As it is used herein, the term “carbo-silicon compounds” refers, for convenience, to both carbo-silanes and carbo-siloxanes. It will be appreciated that any of the above mentioned compounds may contain additionally functional groups compatible with the compound other than those characteristic of the compound.

### A. Method of Preparing Carbo-Silicone Compounds:

According to certain preferred embodiments of the present invention, provided are processes for preparing carbo-silicone compounds comprising contacting, in the presence of a hydrosilation catalyst and under hydrosilation promoting conditions, a silicon reactant and a functionalized olefin reactant

1. The Silicon Reactant:

The silicon reactant used in the process of the present invention is characterized by having at least one silane functional group, that is a Si—H functional group. Optionally, bonded to the silicon atom of the silane functional group are one or more hydrolyzable substituents, for example, halogen, for example chlorine, and alkoxy, for example, methoxy. As illustrated herein, the silicon reactant can additionally contain other substituents on the silane silicon atom, for example, hydrocarbon moieties, as well as other silicon atoms which are substituted with siloxane and/or hydrocarbon moieties.

Silicon reactants suitable for use in the processes of the present invention can contain more than one silane functional group, each of which can optionally have bonded to the silicon atom thereof one or more hydrolyzable substituents (also referred to herein for convenience as a functionalized silane functional group) and can contain within their structure mixtures of two or more of these various silane and functionalized silane functional groups. Accordingly, dimer, oligomer, and polymer compounds having at least one silane functional group, optionally more than one silane functional group, one or more up to all of which are optionally functionalized silane functional groups, are suitable for use as silicon reactants in the present invention processes. Suitable silicon reactants can contain additionally other substituents, including mixtures of other substituents, for example, alkyl, heteroalkyl, aryl, silane, and siloxane substituents. Suitable substituents include silane, carbo-silane, siloxane, or carbo-siloxane moieties, including linear and branched silane, carbo-silane, siloxane, and carbo-siloxane polymers.

In some processes of the invention, preferred silicon reactants are those having the general formula of a compound of Structure I:

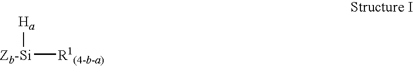

wherein
“a”=1, 2, or 3 and “b”=0, 1, 2, or 3, and are independently selected such that “a”+“b” is less than or equal to 4,
“Z” is a hydrolyzable substituent, and
“R^{1”} is independently selected from the group consisting of: (i) silicon-based moieties selected from the group consisting of silanes, carbosilanes, linear, branched, and cyclic siloxanes, carbosiloxanes, and oligomers, polymers, and copolymers of two or more thereof, which are optionally substituted with one or more hydrolyzable functional groups on one or more silicon atoms thereof; and (ii) saturated or unsaturated, linear, branched, or cyclic, aliphatic or aromatic, hydrocarbon moieties which are optionally substituted on any carbon thereof with an alkyl, aryl, hydroxyl, alkoxy, or halogen moieties.

(a) Hydrolyzable Substituents in the Silicon Reactants (“Z”):

With reference to Structure I, the optional “Z” hydrolyzable substituent(s) in a silicon reactant of the invention are characterized in that they will hydrolyze in the presence of water to yield a silanol functional group, but are not reactive with a hydrosilation catalyst under hydrosilation conditions.

In some preferred silicon reactant compounds, the hydrolyzable substituent(s) are selected independently for each occurrence from the group consisting of alkoxide (R*—O) and halogen. The alkoxide “R*” moiety can comprise saturated or unsaturated, linear, branched, or cyclic alkyl moieties. It is generally preferred if the “R*” moiety does not present significant stearic hindrance, and accordingly, in some preferred silicon reactant compounds, the alkoxy group preferably contains less than five carbon atoms. In some especially preferred silicon reactants, the hydrolyzable substituents are selected from the group consisting of chloride and methoxy substituents.

Examples of hydrolyzable substituents which can be present in silicon reactants suitable for use in the process of the present invention include, but are not limited to, alkoxy, halogen, siloxy, hydride, ketoximino, dialkylamino, acetamide, alkylthio, N,N-dialkylaminoxy, benzamide, acyloxy, enoxy, and the like. It will be appreciated that hydrolyzable substituents which can be included in silicon reactants suitable for use in the present invention processes are any of those available as products of any synthetic process now known or which later becomes available. Thus, suitable silicon reactants containing hydrolyzable substituents for the present invention process are selected on the basis of the chemical compatibility of the functional groups present on the silicon reactant and the olefin reactant(s) present in the hydrosilation reaction mixture.

It will be appreciated that some hydrolyzable groups which can coexist with other functional groups in the same compound may not be chemically compatible when present on different reagents under hydrosilation reaction conditions. Thus, the hydrolyzable substituents on a silicon reactant must be selected in consideration of the functional groups which may be present in an olefin reactant in the reaction mixture. As an example, triacetoxysilane would not be compatible with an amine functionality on the olefin reactant under hydrosilation conditions. Other unsuitable combinations will be apparent.

(b) Substituents in a Silicon Reactant (“R¹”):

In addition to a hydrolyzable substituent, silicon reactants suitable for use in the inventive process can optionally contain other substituents bonded to the silicon atom of a silane functional group therein. With reference to Structure I, these optional substituents are designated as “R¹” groups. The “R¹” groups can comprise a hydrocarbon moiety or a silicon moiety.

Suitable R¹ groups comprising a hydrocarbon moiety include linear, branched, or cyclic, saturated or unsaturated, substituted or unsubstituted alkyl groups, and aromatic and substituted aromatic groups, including aryl and substituted aryl substituents. In some preferred silicon reactants, the “R¹” group is methyl and ethyl, in other preferred silicon reactants the “R¹” group is an unsubstituted aryl functional group, such as phenyl. Optionally, the hydrocarbon group can be substituted. Suitable substituents for the hydrocarbon group include alkoxy and halogen substituents.

When the “R¹” substituent comprises a silicon moiety it can comprise a carbo-silane moiety, for example, a trimethylsilane substituent on an alkylene moiety, a carbo-siloxane moiety, for example, trimethylsiloxane and tetramethyldisiloxane, as well as more complex carbo-siloxane moieties, for example, the moiety of Structure II:

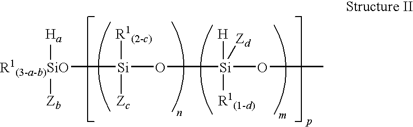

wherein “Z” and “R¹” are as defined above and, preferably, R¹ is methyl, “n”, “m”, and “p” are integers including zero, and are selected independently for each occurrence where “m” is equal to 1 for at least one occurrence of “p”=1, and
   “a” and “b” are integers selected independently to be 0, 1, 2, or 3, and are selected such that a+b=3 or less,
   “c” is an integer selected independently to be 0, 1, or 2,
   “d” is an integer selected independently to be 0 or 1;
   provided that and R¹ and Z are selected to be chemically compatible with each other and with Si—H.
      In certain embodiments which possess a plurality of “R¹” substituents, individual “R¹” substituents may be selected independently of each other. Also, in certain preferred embodiments, “n” is from about 1 to about 8, “m” is from about 1 to about 2, “R¹” is methyl, and any silicon atom is optionally substituted with one or more alkoxy or chloro functional groups replacing a methyl substituent thereof.

Other silicon atom-containing substituents will be apparent to those skilled in the art. For example, it will be appreciated that the general structure shown in Structure II contemplates cyclic siloxane polymers. Thus, for example, any two of the “R¹” substituents shown in Structure I may be portions of a cyclic siloxane polymer, for example, that shown in Structure XI below wherein two of the R¹ groups constitute the cyclosiloxane structure shown.

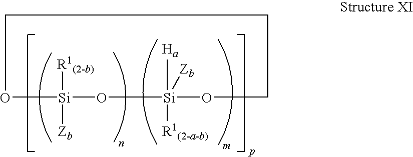

wherein “R¹”, “Z”, “m”, “n”, and “p” are as defined above and are selected with values providing a stable siloxacycle,
   “a” and “b” are selected independently for each occurrence to be 0, 1, or 2, and are selected such that “a”+“b” in a given occurrence is 2 or less.

It will be appreciated further that Structure II contemplates a carbosiloxane substituent having the structure of Structure XIII:

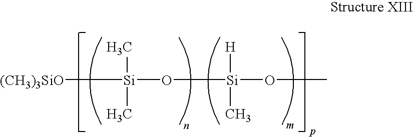

wherein “n”, “m”, and “p” are as defined above.

It will be appreciated that in addition to the substituents described above, oligomers, polymers, and copolymers of these and other hydrocarbon, carbo-silane, and carbo-siloxane moieties, and copolymers of any two or more of these may be substituents on one or more of the silicon atoms in a functionalized silane functional group in a silicon reactant suitable for use in the process of the invention.

It will be appreciated that any silane, siloxane, and carbo-siloxane moiety having a reactive Si—H functional group which is chemically compatible with the desired hydrocarbon reagent can be employed in the reaction of the invention. In addition, it will be appreciated that the silicon and, if present, hydrocarbon portions of these moieties can additionally be substituted with the hydrolyzable functional group described above which is chemically compatible with the intended olefin reactant.

Any silicon-containing compound having a silane functional group (Si—H) present therein which is reactive under hydrosilation conditions and which is chemically compatible with the olefin reactants present in the reaction mixture can be employed in the present invention reaction. It will be appreciated that this includes any such silicon-containing compound available by a synthetic procedure now known or which becomes available.

2. The Functionalized Olefin Reactant

The functionalized olefin reactant is characterized as containing the following moieties: (a) a terminal unsaturated carbon functional group or olefin group which is bonded to an alkylene moiety comprising at least one carbon atom (that is, at minimum, a methylene moiety); and (b) a tertiary carbon moiety to which a second terminal functional group is bonded. The second functional group is characterized by functionality having a substantial potential to impede or compete with a typical hydrosilation reaction, as described below. In general, the functionalized hydrocarbon will be of Structure III:

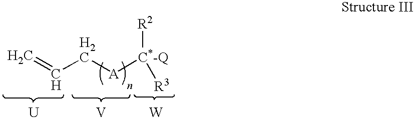

wherein section “U” designates an unsaturated hydrocarbon functional group;
   section “V” designates an alkylene moiety;
   section “W” designates a tertiary carbon moiety having a second functional group Q and protective groups R2 and R3;
   “n” is an integer equal to 0 or 1;
   and “A”, “Q”, “R²” and “R³” are as defined below.

Compounds of Structure III can contain more than one of each of regions “V” and “W” and still be with the scope of applicants' invention. Each of these regions will be described in turn.

(a) Alkylene Portion of the Olefin reactant (Region “V”):

Region “V” of Structure III comprises the alkylene portion of the functionalized olefin reactant. The alkylene portion is characterized in that it comprises a saturated or unsaturated, linear or branched, aliphatic or alicyclic moiety (as these terms are defined in Hack's Chemical Dictionary 4^{th} Edition) which has bonded to a carbon atom thereof at least one terminal unsaturated functional group (Region “U”). Region “V” is also characterized in being bonded to at least one tertiary carbon atom (carbon C* in Region “W”, defined below).

With further reference to Figure III, at minimum the region “V” alkylene portion of the functionalized olefin reactant comprises a methylene carbon, that is, a —CH₂— moiety. In that instance “n”=0, and the tertiary carbon atom (C* of Region “V”) is bonded to a carbon allylic to the terminal unsaturated functional group (Region “U”). In some preferred embodiments, “n”=1 and “A” is an alkylene moiety. In some preferred reactants, the alkylene portion of the functionalized olefin reactant contains optionally a heteroatom functional group. In some preferred functionalized olefin reactants, the “A” portion of Structure III can comprise a heteroatom-containing moiety selected from the group consisting of —[CH₂]_{c}—S—[CH₂]_{d}, —[CH₂]_{c}—O—[CH₂]_{d}, and —[CH₂]_{c}—N(R⁴)[CH₂]_{d}—, wherein “c” is an integer including 0, “d” is at least one, and R⁴ is an alkyl moiety having less than about three carbon atoms.

(b) Terminal Unsaturated Carbon Portion of the Olefin reactant (Region “U”):

With further reference to Structure III, the functionalized olefin reactant of the present invention comprises also a terminal unsaturated carbon functional group, designated in Structure III as region “U”. The unsaturated carbon functional group contains at least one multiple bond between two carbon atoms. In some preferred functionalized olefin reactants the unsaturated carbon functional group is a carbon-carbon double bound, that is, an olefin, and more preferably, the unsaturated carbon functional group is a terminal olefin. It will be appreciated that any unsaturated carbon functional group which can undergo addition of a silane functional group in a silicon reactant under hydrosilation reaction conditions can be used as the unsaturated carbon functional group. It will also be appreciated that the alkylene portion of a functionalized olefin reactant (Region “V”) can be bonded to more than one unsaturated hydrocarbon functional group, permitting multiple sites of hydrosilation reaction to occur.

(c) Second Functional Group of the Olefin reactant (Region “W”):

With further reference to Structure III, Region “W” of the structure comprises a tertiary carbon atom (designated “C*” in Structure III) to which is bonded a second functional group, designated “Q” in structure III. The tertiary carbon atom is characterized by having no protons bonded directly to it. As indicated in Structure III, the C* carbon is bonded to the alkylene portion of the olefin reactant (Region “V”), R², R³ and the “Q”-group.

Without being bound by or subscribing to any particular theory of the inventive process, it is believed that the presence of the tertiary carbon atom in a position located between the terminal unsaturated carbon functional group and the second functional group reduces or eliminates the potential of the “Q”-group to impede a hydrosilation reaction. It is thought that the tertiary carbon atom reduces or eliminates this potential by eliminating the “Q”-group's ability to conjugate with the terminal unsaturated carbon functional group and/or by stearicly hindering chemical attack on the “Q”-group. Additionally, it is thought that increasing the size of the R² and R³ (e.g. phenyl vs. methyl) substituents decreases this potential.

The R² substituent is selected from the group consisting of saturated or unsaturated, linear, branched, or cyclic, aliphatic, aromatic, and substituted aromatic hydrocarbon moieties, including vinyl, and a moiety of the structure of Structure IV:

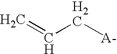

wherein “A” is as defined above for Structure III. The choice of substituents is guided by desired physical properties such as temperature stability or compatibility with other materials. In some preferred functionalized olefin reactants the R² substituent is a methyl, ethyl or phenyl group.

The R³ substituent is selected from the group consisting of saturated or unsaturated, linear, branched, or cyclic, aliphatic or aromatic, hydrocarbon moieties. In general, for stearic reasons, R³ will be selected to have less than seven carbon atoms, and more preferably is selected from methyl and phenyl substituents.

The Q-group is selected from functional groups which are known to provide functionality having a substantial potential to impede a hydrosilation reaction, as defined herein. As the phrase is used herein, functionality having a “substantial potential to impede a hydrosilation reaction” is reflected by a hydrocarbon's inability to produce, to any substantial degree, a desired product from a hydrosilation reaction.

A desirable product is generally the formation of a carbon silicon bond between a carbon atom in the unsaturated functional group of the olefin reactant used in the reaction and a silicon atom in an Si—H functional group of the silicon reactant used in the reaction. As described above, conventional hydrosilation reactions employing typical olefin reactants which contain also certain second functional groups fail to yield the expected product, or a useful amount of the expected product.

One method of identifying second functional groups which impart functionality with a substantial potential to impede a hydrosilation reaction is to run a test hydrosilation reaction using a hydrocarbon reagent which contains a linear alkylene moiety (that is, —(CH₂)ₙ—), terminated on one end by an olefin functional group (H₂C═CH—) and on the other end by the second functional group of interest. Test reagents which fail to provide the expected hydrosilation products, or which provide yields of the expected hydrosilation product which are substantially lower than those provided by reaction of the same silane under substantially similar hydrosilation conditions with a functionalized olefin reactant of the invention containing the same second functional group, are those which impart functionality having a substantial potential to impede a hydrosilation reaction. It is preferred for test olefin reactants to have an alkylene moiety of “n”=4 or less, and more preferred for test olefin reactants to have an alkylene moiety of “n”=1. Other methods of identifying second functional groups which impart functionality having a substantial potential to impede a hydrosilation reaction will be apparent to those skilled in the art.

The “Q”-group is selected such that it does not react with any hydrolyzable substituent optionally appended to a silicon atom in the silane reactant with which the selected functionalized olefin reactant is contacted. Examples of preferred “Q” functional groups include an aldehyde, nitrile, and imino functional groups. It will be appreciated that there are numerous other “Q” functional groups which can be included in a functionalized hydrocarbon suitable for used in the inventive process. For example, other functional groups include ester, amido, epoxide, amino, aminomethylbenzylamine, acid halide, linear and cyclic acid anhydrides, mercapto, acrylates, methyl acrylates, carbamido, hydroxyl, alpha- and betahydroxy acids, fluorine substituted aryl ketone, nitrile, imino, isocyanate, methyl acryloxy, carboxylic acid, ureido, fluorophenoxy, aminophenoxy phenyl, Schiff Base, maleide, and functional groups having the following structures:

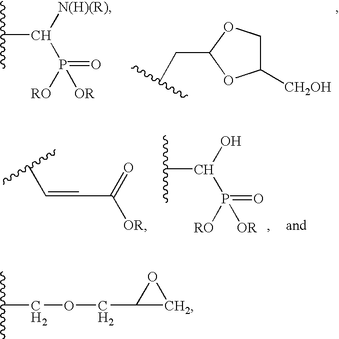

wherein R is a C₁ to C₆ branched, straight-chain, or cyclic alkyl, or aryl.

It will be appreciated that one manner of preparing these various functional groups is by conversion of an aldehyde functional group. Accordingly, these groups may be provided in a functionalized olefin reactant by conversion of an aldehyde functional group in an aldehyde substituted functionalized olefin reactant prior to utilizing the reactant in a hydrosilation reaction. Alternatively, a carbo-silicon compound prepared by the inventive process from a functionalized olefin reactant containing an aldehyde group can be derivatized to provide one of these functional groups at the site of the aldehyde functional group. The feasibility of providing such functionalized hydrocarbon compounds by either route will be apparent to those of ordinary skill, guided by the above-described principles and by considerations of the other functional groups present in the particular silicon and functionalized olefin reactants selected and the carbo-silicon product compounds prepared by the inventive process.

Although it will be apparent that functionalized olefin reactants can be provided using many synthetic pathways, one convenient method of preparing various allylic-2,2-disubstituted, functionalized olefin reactants of Structure III is described by Brannock in the Journal of the American Chemical Society, Volume 81 (1959) pp. 3379 to 3383. Accordingly, condensing allyl alcohol with aldehydes which have the desired R² substituent on a carbon which is beta to the aldehyde functional group (thus, the R³ functional group is provided by the remainder of the parent aldehyde carbon chain bonded to the carbon beta to the aldehyde functional group) provides coupling of the allylic carbon to the beta-carbon of the parent aldehyde. In this manner, aldehyde functionalized olefin reactants of virtually any R² and R³ substituent can be prepared through selecting the appropriate starting aldehyde.

When it is desirable to provide functionalized olefin reactants which include a heteroatom in the alkylene portion of the reactant (identified in Figure III as the “A” group within the “V” portion of the functionalized, olefin reactant), these reactants can be provided by, for example, condensing allyloxyethyl bromide with the appropriate isoaldehyde utilizing the methods of Subramanian et. al., as described in Chemistry and Industry, vol. 16, September 1978, beginning on page 731, which are incorporated herein by reference in their entirety. In this condensation, tetrabutyl ammonium iodide is employed as a phase transfer catalyst in benzene over solid sodium hydroxide. Other synthetic methods for providing appropriate functionalized olefin reactants will be apparent.

As will be appreciated, by varying the structure of the “Q” group consistent with the above-described principles, the inventive process can provide a wide variety of functionalized carbo-silicon compounds by direct reaction of the selected silicon and functionalized olefin reactants.

3. The Hydrosilation Reaction:

As described above, applicants' have surprisingly discovered that a hydrosilation process can be carried out between a silicon reactant and a functionalized olefin reactant to yield directly functionalized carbo-silicon compounds. In general, a hydrosilation catalyst is a metal complex which is used in catalytic amounts that increases the rate and/or shifts the equilibrium of a hydrosilation reaction as that phrase has been defined herein. In addition, a hydrosilation catalyst will be selected that is preferably compatible with the functional groups on the reactants to be employed in the process of the invention. In some preferred reactions, chloroplatinic acid is employed as the hydrosilation catalyst. Other hydrosilation catalysts which can be employed include tris(triphenylphosphine) Rh (1) chloride, bis(diphenylphosphino)binapthyl palladium dichloride, and dicobalt dioctylcarbonyl. It will be appreciated that there are other catalysts now known or which may become known that may be used in promoting the inventive hydrosilation reaction. In general, these will be selected using the same known criteria employed in the selection of catalysts for any other hydrosilation reaction and include the cost of the catalyst, its ability to promote equilibrium in favor of products and its selectivity for the desired product.

As will be apparent, any conditions which promote the hydrosilation reaction can be employed. In general this involves contacting, in the presence of a hydrosilation catalyst, at least one silicon reactant, as defined above, and at least one functionalized olefin reactant, as defined above. Preferably, to facilitate the reaction, the reactants are heated to a temperature above ambient, that is, above about 25° C. More preferably, the reactants are heated to a temperature from about 50° C. to about 170° C., or as necessary to obtain conversion of the olefin to the reaction product. As would be known to one skilled in the art, if the reaction is conducted at too low of a temperature, then little or no reaction will occur. For example, when tetramethyldisiloxane is reacted with 2,2,-dimethyl-4-pentenal in the presence of a platinum catalyst at 85° C. for 48 hours, almost no conversion or addition of the olefin to the hydride-containing disiloxane occurs. However, when the reaction is conducted at 125° C., significant conversion occurs.

In some preferred reaction processes, the functionalized olefin reactant is utilized in an amount such that the number of moles of unsaturated carbon functional group present in the functionalized olefin reactant is in excess of the number of moles of silane functional groups present in the entire amount of silicon reactant to be used in the reaction. In other preferred reaction processes of the invention, the amount of functionalized olefin reactant employed provides an equal-molar amount of unsaturated hydrocarbon functional group relative to the number of moles of silane functional group contained in the entire amount of silicon reactant employed in the reaction.

In some preferred reaction processes, an amount of the functionalized olefin reactant is employed that it can serve as a reaction medium in which the hydrosilation catalyst is dissolved or suspended. When this amount of functionalized olefin reactant is employed, the mixture of reactant and hydrosilation catalyst is heated and the silicon reactant is added in small aliquots as the reaction proceeds.

It will be apparent that, guided by generally recognized chemical principles, many other reaction arrangements may be employed, including utilizing a common solvent for the various reactants. The present invention process can be carried out under a wide range of hydrosilation conditions. In some preferred reaction processes of the invention, the functionalized olefin reactant will be present in a 1,1-fold stoichiometric excess relative to the amount of silane functional groups in the silicon reactant to be employed, chloroplatinic acid will be used as the hydrosilation catalyst, and the reaction will be carried out by contacting the functionalized olefin reactant and silicon reactant at a temperature from about 50° C. to about 170° C.

Some preferred processes of the present invention comprises contacting, under hydrosilation-promoting conditions, a reaction mixture comprising a solvent which contains a hydrosilation catalyst and at least one functionalized olefin reactant, and adding thereto, at a temperature which promotes a hydrosilation reaction, at least one silicon reactant in an amount providing equal-molar quantities of silane functional group and unsaturated hydrocarbon functional group.

### 2. Novel Carbo-Silicon Compounds:

The present invention also provides carbo-silicon reaction products prepared in accordance with the above-described process. These products comprise substantially products of addition of a silane functional group of a silicon reactant (for example, those of Structure I, described above) across an unsaturated carbon functional group of a functionalized olefin reactant (for example, those of Structure III described above). Thus, the present development provides novel compounds having the formula of Structure V, below.

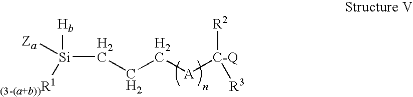

wherein
“a” and “b” are integers, including zero, selected independently such that “a”+“b” is equal to or less than 3,
“Z”, “Q”, “A”, “n”, “R^{1”}, “R^{2”}, and “R³” are as defined above.

Based on the principles and processes described herein, it will be appreciated that, guided by the principles of chemical compatibility, the compounds of the present invention are those in which any of the following “Z” substituents can be present: (a) halogen; (b) alkoxy; (c) ketoximino; (d) dialkylamino; (e) acetamide; (f) alkylthio; (g) N,N-dialkylaminoxy; (h) benzamide; (i) acyloxy; and (j) enoxy substituents (each of which is represented in Table 1 by a column labeled with the corresponding letter), with the following “Q” functional groups: (1) ester; (2) amido; (3) epoxy; (4) amino; (5) aminomethylbenzylamine; (6) acid halide; (7) acid anhydride; (8) mercapto; (9) acrylate; (10) methyl acryloxy; (11) carbamido; (12) hydroxyl; (13) alpha-hydroxy acid; (14) betahydroxy acid; (15) fluorine substituted aryl ketone; (16) nitrile; (17) imino; (18) isocyanato; (19) aldehyde; (20) carboxylic acid; (21) ureido; (22) fluorophenoxy; (23) aminophenoxy phenyl; (24) Schiff Base; (25) maleide; (26) a functional group of Structure VI; (27) a functional group of the formula of Structure VII; (28) a functional group of Structure VIII; (29) a functional group of Structure IX; and (30) a functional group of Structure X (each of which is represented in Table 1 below by a row labeled with the corresponding number), wherein the functional groups Structures VI, VII, VIII, IX, and X have the following structures:

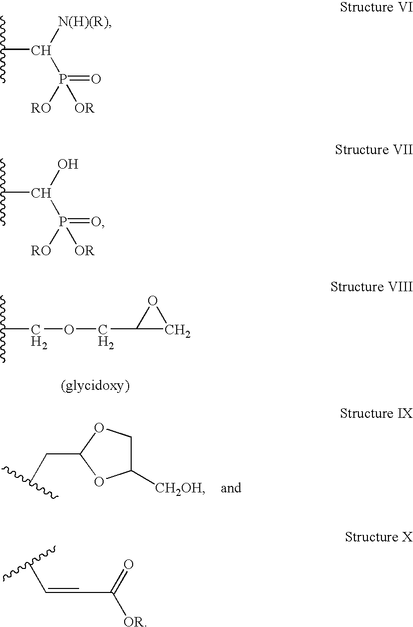

Although the compatibility of each of these groups will also vary depending upon the other substituents present in the molecule, Table I generally indicates with an “X” (i.e. in the box at the intersection of a given row and column containing various of these functional groups) when a compound containing the indicated functional groups can not be formed directly by the process of the present invention due to chemically incompatible under hydrosilation conditions. It will be apparent that some of these combinations can be prepared indirectly by preparing a compound of the invention form chemically compatible silicon and functionalized olefin reactants and derivatizing one or both of the types of functional groups in a subsequent reaction.

TABLE I

| “Q” Substituent | Hydrolyzable Substituent | | | | | | | | | |
|---|---|---|---|---|---|---|---|---|---|---|
| (number from | (letter from | | | | | | | | | |
| enumerated | enumerated list) | | | | | | | | | |
| list | a | b | c | d | e | f | g | h | i | j |
| 1 | | | | | | | | | | |
| 2 | X | | | A | A | A | A | A | A | |
| 3 | X | | | | | | | | | |
| 4 | X | | | | | | | | A | |
| 5 | A | | | | | | | | A | |
| 6 | | A | A | A | A | A | A | A | | |
| 7 | X | | | A | A | | A | A | | T |
| 8 | | X | | | | | | | | |
| 9 | | | | T | | T | T | | | |
| 10 | | | | T | | T | T | | | |
| 11 | X | | | | | | | | X | |
| 12 | A | T | | | | | | | | T |
| 13 | A | T | | | | | | | | |
| 14 | A | T | | | | | | | | |
| 15 | | | | | | | | | | |
| 16 | | | | | | | | | | |
| 17 | X | | | | | | | | X | |
| 18 | | | X | X | X | | X | X | X | |
| 19 | | | | | | | | | | |
| 20 | X | T | | X | T | | X | T | T | |
| 21 | X | | | | | | | | X | |
| 22 | | | | | | | | | | |
| 23 | X | | | | | | | | X | |
| 24 | X | | | | | | | | X | |
| 25 | | | | | | | | | | |
| 26 | X | T | | X | T | | X | T | T | |
| 27 | X | | | X | | | X | | X | |
| 28 | X | T | | | | | | | | T |
| 29 | X | X | | | | | | | | |
| 30 | | | | T | | T | T | | | |

X = incompatible reactants
T = compatible reactants, temperature sensitive product
A = compatible reactants, proton acceptor needed to stabilize reaction conditions

It will be further appreciated that any of the sets of compatible hydrolyzable substituents and “Q” functional groups indicated by Table I above may be present in a compound of the formula of Structure V with any of the above described R¹ functional groups or R² or R³ substituents.

In a preferred embodiment, carbo-silicone compounds according to the present invention include, for example, 2,2-dimethyl-4-pentenoic acid-acetic acid anhydride-tri-acetoxy-silane having the formula:

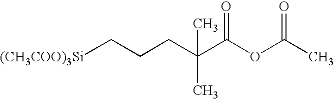

### Examples

The following examples illustrate the hydrosilation process and carbo-silicon products of the present invention and not to limit the scope thereof. One skilled in the art could readily modify any of the examples or specific embodiments described herein so as to optimize the process for optimal yield. Such modifications, as are made obvious by this disclosure, are intended to be part of this description though not expressly stated herein, and are intended to be within the spirit and scope of the invention.

### Examples 1-6

The Example process is carried out by placing an aliquot of the selected functionalized olefin reactant into a reaction flask equipped with an external heat source, a reflux condenser, a stirring apparatus, and a dropping funnel. The reaction flask thus charged is purged with nitrogen to maintain an inert atmosphere and the dropping funnel charged with the selected silicon reactant. The reaction is maintained under an inert atmosphere and 0.025 mole of chloroplatinic acid is added to the olefin reactant as a 0.1 M solution in isopropanol. The reaction flask is heated initially to about 110° C. After the initial temperature is reached, the silicon reactant is added dropwise with continued stirring. The reaction temperature is maintained at a temperature from about 100° C. to about 120° C. either by continued heating or by adjusting the rate of addition of the silicon reagent, or a combination of the two. After all of the silicon reactant has been added the reaction temperature is maintained by continued heating with stirring for three additional hours. At the end of the reaction period, reaction completion is verified by assaying the reaction mixture for residual functionalized olefin reactant and for carbo-silicon product by gas chromatographic analysis (GC) using published methods. In some reactions, additional heating to temperatures as high as 170° C. were performed to increase the initial yield or conversion.

In all cases, the product formed was isolated by fractional distillation, at reduced pressure as needed, and the isolated product was analyzed by published infrared spectroscopic methods to verify the product formed in the reaction.

In addition to the reactants prepared as described below, trichlorosilane (99% purity), dimethylchlorosilane (99% purity), and tetramethyldisiloxane 97% purity (silicon reactants) were obtained from Aldrich used as received. All other reagents were ACS grade reagent articles of commerce obtained from commercial sources.

(a) Preparation of Functionalized Olefin Reactants

Using the procedures described by Brannock in the Journal of the American Chemical Society, vol 81 (1959) pp 3379 to 3383, the following olefin reactants were prepared: 2,2-dimethyl-4-pentenal; and 2-allyl-2-ethyl-4-pentenal.

A portion of the 2,2-dimethyl-4-pentanal was converted to the corresponding 2,2-dimethyl-4-pentenonitrile by placing into a reaction vessel 11.2 g of the aldehyde, 6.9 g of hydroxylamine hydrochloride (99% purity, Aldrich), and 75 ml of N-methylpyrrolidone (99% purity, Aldrich: M-PYROL®), and heating, with stirring, to a temperature of about 90° C. to initiate a reaction. The reaction mixture was left stirring until the exotherm subsided, then the contents were poured into a 10 fold volume of water. The organic layer was separated and the nitrile was isolated by fractional distillation, collecting the fractions distilling at a temperature from about 146 C to about 148 C.

2,2-dimethyl-4-allyloxybutenal was prepared from allyl alcohol and ethylene bromide by published methods. The resulting allyl intermediate was reacted with isobutraldehyde in accordance with published methods (Subramanian et al, Chemistry and Industry, Vol. 16 (1978) page 731) to yield the allyloxyaldehyde.

(b) Preparation of the Carbo-Silanes

Carbo-silanes of the invention were prepared using the inventive process by reacting the functionalized olefin reactant indicated in rows 1 through 3 of Table II, below, with the indicated silane silicon reactant to yield the indicated product by the above-described procedure.

Carbo-siloxanes were prepared using the inventive process by reacting the functionalized olefin reactant indicated in rows 4 of Table II with the indicated siloxane silicon reactant to yield the indicated product. The product of Example 4 was prepared by the above-described procedure.

In each of the Examples, the mole % conversion of functionalized olefin reactant indicated in the table was determined by GC, as described above.

TABLE II

| Ex. No. | Silicon Reactant | Functionalized Olefin reactant | Product | Yield* |
|---|---|---|---|---|
| 1 | trichlorosilane | 2,2-dimethyl-4 pentenal | 2,2-dimethyl-5-trichlorosilyl- | 85% |
| | | | pentanal | |
| 2 | dimethyl-chlorosilane | 2,2-dimethyl-4 pentenal | 2,2-dimethyl-5-dimethyl- | 50% |
| | | | chlorosilyl-pentanal | |
| 3 | dimethyl-chlorosilane | 2,2-dimethyl-4-pentenonitrile | 1,1-dimethyl-5-(dimethyl- | 75% |
| | | | chlorosilyl)-pentanonitrile | |
| 4 | tetramethyl- | 2,2-dimethyl-4-pentenonitrile | 1,2-bis(2,2-dimethyl-4- | 82% |
| | disiloxane | | pentanonitrile)-tetramethyl- | |
| | | | disiloxane | |
| 5 | tetramethyldisiloxane | 2,2-dimethyl-4pentenal | 1,2-bis(2,2-dimethyl-4- | 50% |
| | | | pentanal)- | |
| | | | tetramethyldisiloxane | |
| 6 | trimethoxysilane | 2,2-dimethyl-4pentenal | 2,2-dimethyl-5- | 80% |
| | | | trimethoxysilylpentanal | |

*% base on moles of olefin reactant consumed

These examples demonstrate that the process of the present invention provides a facile, high yield route to direct production of carbo-silicon compounds having mixtures of substituents, including those which can not be provided by derivative routes and including those which have a substantial potential to impede a hydrosilation reaction.

### Example 7

The following procedure was followed to convert a portion of the product prepared in Example 4 (1,1-dimethyl-5-(dimethylchloro-silyl)-pentanonitrile) to a disiloxane. Into a vessel was placed 19.1 g of potassium hydroxide dissolved in 175 ml of a solvent consisting of a water/ethanol mixture (80:20 v/v). To this solution, 17 g of the nitrile was added slowly (over about 30 minutes), resulting in a milky-white emulsion. The emulsion was brought to reflux and reflux was maintained for about 25 hours. When no ammonia evolution from the reflux condenser could be detected with pH paper, the reaction mixture was cooled to ambient temperature and acidified with aqueous HCl. The upper phase which formed upon acidification was isolated and extracted with 100 ml aliquots of chloroform. The extracts were combined and the chloroform was stripped in a rotary evaporator, leaving behind a viscous liquid. Infrared analysis confirmed that the product obtained was 1,3-bis[5-(2,2-dimethyl-pentanoic-acid)]-1,1,3,3-tetramethyl-disiloxane (a siloxane dimer of the starting carbo-silane compound with concomitant oxidation of the cyanide functional groups to carboxylic acid functional groups).

This example demonstrates the carbo-silicon compounds of the invention can have utility as intermediates in the formation of siloxane oligomers.

### Examples 8-12

Using the procedures described by Brannock in the Journal of the American Chemical Society, vol 81 (1959) pp 3379 to 3383, 2,2-dimethyl-4-pentanoic acid can be prepared. The acid can be reacted with thionyl chloride in the presence of potassium carbonate using published methods to yield the corresponding 2,2-dimethyl-4-pentenoyl chloride.

Carbo-silanes of the invention will be prepared according to the process of the present invention utilizing the procedure described above. Thus it will be found that when a functionalized olefin reactant indicated in Examples 8 to 11 (Table III, below) is reacted with a silicon reactant as indicated in Table III, in accordance with the above-described procedure, there will be formed the product indicated in Table III.

TABLE III

| | | Functionalized Olefin | |
|---|---|---|---|
| Ex. No. | Silicon Reactant | reactant | Product |
| 8 | triacetoxysilane | 2,2-dimethyl-4-pentenal | 2,2-dimethyl-5- |
| | | | (triacetoxysilyl)-pentenal |
| 9 | trichlorosilane | 2,2-dimethyl-4- | 2,2-dimethyl-5- |
| | | pentenoylchloride | (trichlorosilyl)- |
| | | | pentanoylchloride |
| 10 | Trichlorosilane | 2-allyl-2-ethyl-4-pentenal | 2,2- |
| | | | bis(trichlorosilylpropyl)- |
| | | | butraldehyde |
| 11 | trichlorosilane | 2,2-dimethyl-4- | 2,2-dimethyl-4- |
| | | allyloxybutenal | trichlorosilylpropoxybutanal |
| 12 | disilane-10- | 2,2dimethyl-4-pentenal | bis(2,2-dimethyl-4- |
| | mer-dimethyl- | | pentanal)silyl-10-mer- |
| | siloxane | | disiloxane |

It will also be found that the carbo-siloxane shown in Example 12 of Table III will be prepared by reacting a siloxane silicon reactant and a functionalized olefin reactant indicated in Example 12 using the following procedure.

The siloxane reactant of Example 12, a trimethyl silyl capped dimethyl siloxy/methyl silane silicone fluid having a formula which corresponds to the average structure of Structure IX, will be prepared using published methods.

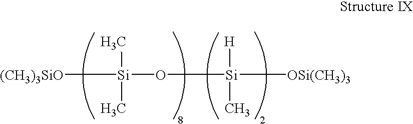

The compound that will be formed by this procedure is referred to herein for convenience as the “disilane-10-mer-dimethyl-siloxane”.

The carbsiloxane of Example 12 will be prepared utilizing the above-described procedure modified by including a solvent (200 ml of toluene) to dissolve the silicon reactant, which will be found to be a viscous liquid. The reaction will be carried out by periodically monitoring the refluxing the reaction mixture utilizing infrared (IR) analysis of an aliquot of the reaction and continuing the reflux until no Si—H functional group can be detected in the reaction mixture.

It is expected that the foregoing Examples 8 to 12 will provide the indicated product in a yield, based on consumed olefin reactant, which is in excess of that which would be obtained if the olefin reactant utilized in the reaction had a methylene (CH₂) group substituted for the tertiary carbon atom at the 2-position of the hydrocarbon reagent.

Having thus described a few particular embodiments of the invention, various alterations, modifications, and improvements will readily occur to those skilled in the art. Such alterations, modifications, and improvements, as are made obvious by this disclosure, are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A process for preparing a functionalized carbo-silicon compound comprising
contacting, in the presence of a hydrosilation catalyst and under hydrosilation promoting conditions:
a. a silicon reactant containing at least one silane (Si—H) functional group and, optionally, at least one hydrolyzable substituent; and
b. a functionalized olefin reactant containing:
(i) at least one terminal olefin functional group;
(ii) an alkylene segment bonded to said terminal olefin group; and
(iii) a tertiary carbon moiety bonded to said alkylene segment and comprising a second functional group and two alkylene groups, said two alkylene groups reducing the reactivity of the second functional group during hydrosilation of the functionalized olefin reactant.

2. A process for preparing a functionalized carbo-silicon compound comprising
contacting, in the presence of a hydrosilation catalyst, under hydrosilation promoting conditions, a silicon reactant of Structure I with an unsaturated olefin reactant of Structure III, wherein:
the compound of Structure I has the formula: 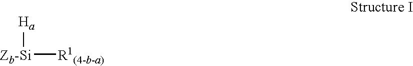
wherein
“a” is 1, 2, or 3 and “b” 0, 1, 2, or 3, selected such that “a”+“b” is less than or equal to 4
“Z” is a hydrolyzable substituent,
“R^{1”} is independently selected from the group consisting of: (i) silicon-based moieties selected from the group consisting of carbosilanes, siloxanes, carbosiloxanes, and polymeric cognitors thereof which are optionally substituted with one or more hydrolyzable functional groups on one or more silicon atoms thereof; and (ii) saturated or unsaturated, linear, branched, or cyclic, aliphatic or aromatic, hydrocarbon moieties which are optionally substituted on any carbon thereof with one or more members selected independently for each occurrence from the group consisting of alkyl, aryl, hydroxyl, alkoxy, and halogen moieties; wherein a plurality of R¹ substituents may be portions of a cyclosiloxane structure;
and wherein the compound of Structure III has the formula: 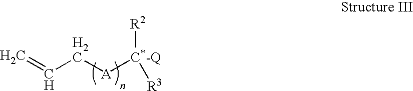
wherein
“n” is 0 or 1,
“Q” is a second functional group characterized by having a substantial potential to impede a hydrosilation reaction,
“A” is selected from —[CH₂]_{c}—S—[CH₂]_{d}, —[CH₂]_{c}—O—[CH₂]_{d}, or —[CH₂]_{c}—N(R⁴)—[CH₂]_{d}, wherein “c” is an integer including 0, “d” is at least one, and R⁴ is an alkyl moiety having less than three carbon atoms,
R² is selected from the group consisting of saturated or unsaturated, linear, branched, or cyclic, aliphatic or aromatic, hydrocarbon moieties and a moiety of the structure of Structure IV: 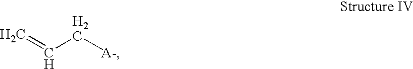
and
R³ is selected from the group consisting of saturated or unsaturated, linear, branched, or cyclic, aliphatic or aromatic, hydrocarbon moieties,
provided that only one of R³ and R⁴ is selected to be an unsaturated moiety.

3. The process of claim 2 wherein Z is selected from the group consisting of alkoxy, halogen, hydride, ketoximino, dialkylamino, acetamide, alkylthio, N,N-dialkylaminoxy, benzamide, acyloxy, and enoxy.

4. The process of claim 3 wherein Z is selected from the group consisting of chloride, methoxy, and ethyoxy.

5. The process of claim 2 wherein Q is selected from the group consisting of aldehyde, ester, amido, epoxide, amino, aminomethylbenzylamine, acid halide, linear and cyclic acid anhydrides, mercapto, acrylates, methyl acrylates, carbamido, hydroxyl, alpha- and betahydroxy acids, fluorine substituted aryl ketone, nitrile, imino, isocyanate, carboxylic acid, ureido, fluorophenoxy, aminophenoxy phenyl, Schiff Base, maleide, and functional groups having the following structures: 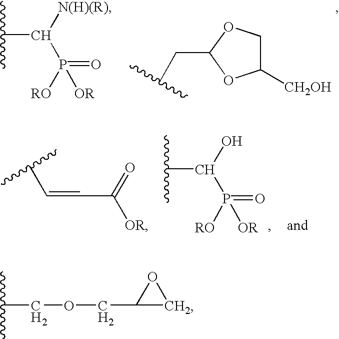
wherein R is a C₁ to C₆ branched, straight-chain, or cyclic alkyl, or aryl.

6. The process of claim 5 wherein Q is selected from the group consisting of aldehyde, nitrile, amino, and imino.

7. The process of claim 1 wherein R³ is phenyl.

8. The process of claims 1 wherein said silicon reactant is a chlorofunctionalized monosilane.

9. The process of claim 8 wherein the silicon reactant compound is selected from the group consisting of trichlorosilane, methyldichlorosilane, and dimethylchlorosilane.

10. The process of claim 1 wherein the functionalized olefin reactant is 2,2 dimethyl-4-pentenal.

11. The process of claim 1 wherein the silicon reactant is a siloxane having an average structure comprising a linear portion which comprises eight dimethylsiloxane structural repeating units, two methylsiloxane structural repeating units and two trimethylsilane end cap moieties.

12. The process of claim 1 wherein the silicone reactant is tetramethyldisiloxane and the functionalized olefin reactant is 2,2-dimethyl-4-pentenal.

13. The process of claim 1 wherein the silicone reactant is tetramethyldisiloxane and the functionalized olefin reactant is 2,2-dimethyl-4-pentonitrile.

14. The process of claim 1 wherein said silicon reactant is selected from the group consisting of trimethyoxysilane and triethyoxysilane.

15. A carbo-silicon compound prepared according to the process of claim 1.

16. The carbo-silicon compound of claim 2 comprising a carbo-silane.

17. The carbo-silicon compound of claim 2 comprising a carbo-siloxane.

18. A compound having the structure of Structure V: 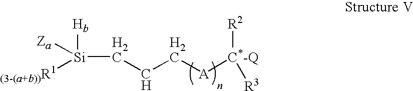
wherein
“a” and “b” are integers, including zero, selected independently such that “a”+“b” is equal to or less than 3;
“Z” is a hydrolyzable substituent;
“Q” is functional group characterized by having a substantial potential to impede a hydrosilation reaction;
“A” is selected from —[CH₂]_{c}—S—[CH₂]_{d}, —[CH₂]_{c}—O—[CH₂]_{d}, or —[CH₂]_{c}—N(R⁴)—[CH₂]_{d}, wherein “c” is an integer including 0, “d” is at least one, and R⁴ is an alkyl moiety having less than three carbon atoms;
“n” is 0 or 1;
“R^{1”} is selected from the group consisting of: (i) silicon-based moieties selected from the group consisting of carbosilanes, siloxanes, carbosiloxanes, and polymeric cognitors thereof which are optionally substituted with one or more hydrolyzable functional groups on one or more silicon atoms thereof; and (ii) saturated or unsaturated, linear, branched, or cyclic, aliphatic or aromatic, hydrocarbon moieties which are optionally substituted on any carbon thereof with one or more members selected independently for each occurrence from the group consisting of alkyl, aryl, hydroxyl, alkoxy, and halogen moieties; wherein a plurality of R¹ substituents may be portions of a cyclosiloxane structure;
“R^{2”} is selected from the group consisting of saturated or unsaturated, linear, branched, or cyclic, aliphatic or aromatic, hydrocarbon moieties and a moiety of the structure of Structure IV: 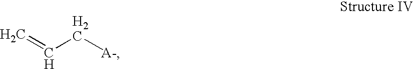
and
“R³” is selected from the group consisting of saturated or unsaturated, linear, branched, or cyclic, aliphatic or aromatic, hydrocarbon moieties,
provided that only one of R³ and R⁴ is selected to be an unsaturated moiety.

19. The compound of claim 18 wherein Z is selected from the group consisting of alkoxy, halogen, hydride, ketoximino, dialkylamino, acetamide, alkylthio, N,N-dialkylaminoxy, benzamide, acyloxy, and enoxy.

20. The compound of claim 19 wherein Z is selected from the group consisting of chloride, methoxy, and ethoxy.

21. The compound of claim 18 wherein Q is selected from the group consisting of aldehyde, ester, amido, epoxide, amino, aminomethylbenzylamine, acid halide, linear and cyclic acid anhydrides, mercapto, acrylates, methyl acrylates, carbamido, hydroxyl, alpha- and betahydroxy acids, fluorine substituted aryl ketone, nitrile, imino, isocyanate, carboxylic acid, ureido, fluorophenoxy, aminophenoxy phenyl, Schiff Base, maleide, and functional groups having the following structures: 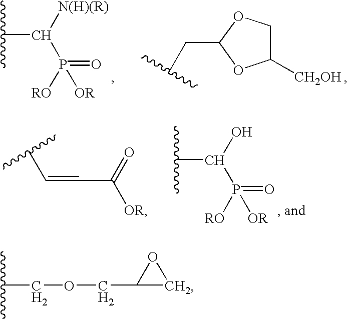
wherein R is a C₁ to C₆ branched, straight-chain, or cyclic alkyl, or aryl.

22. The compound of claim 19 wherein Q is selected from the group consisting of aldehyde, carboxylic acid, ureido, fluorophenoxy, aminophenoxyphenyl, Schiff base, maleide, and functional groups having the following structures:

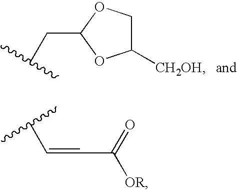

23. The compound of claim 19 wherein Q is selected from the group consisting of aldehyde, nitrile, amino, and imino.

24. The compound of claim 18 wherein R³ is phenyl.

25. The compound of claim 18 selected from the group consisting of 1,2-bis (2,2-dimethyl-4-pentenal)-tetramethyldisiloxane,
1,(2,2-dimethyl-4-pentenal)-tetramethyldisiloxane,
1,2-bis(2,2-dimethyl-4-pentenitrile)-tetramethyldisiloxane, and
1,(2,2-dimethyl-4-pentenitrilel)-tetramethyldisiloxane.

26. The compound of claim 18 having the structure:

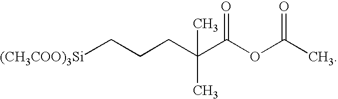

27. A method of producing a functionalized carbo-silicon compound comprising the steps of:
(a) preparing a functionalized olefin reactant comprising an aldehyde moiety; and
(b) attaching said olefin reactant to said carbo-silicon compound via a hydrosilation reaction.
